(19) United States
(12) Patent Application Publication
(10) Pub. No.: US 2009/0145160 A1
(43) Pub. Date: Jun. 11, 2009

(54) BEVERAGE DISPENSING UNIT AND ICE BIN COMBINATION

(76) Inventors: Fernando A. Ubidia, Ludlow, MA (US); Aaron M. Stein, Middletown, CT (US); Richard Paeth, St. Charles, IL (US); Gary L. Myers, Monee, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/324,827

(22) Filed: Nov. 26, 2008

Related U.S. Application Data
(60) Provisional application No. 60/990,593, filed on Nov. 27, 2007.

(51) Int. Cl. B67D 5/62; F25C 5/18

(52) U.S. Cl. 62/391; 62/344; 62/398

(57) ABSTRACT

A drop-in beverage dispensing unit and ice bin combination having a beverage dispenser and an ice bin assembly. The beverage dispenser can have a tower assembly onto which dispensing valves are mounted. An ice bin lid provides access to the ice stored within the ice bin assembly and aids in protecting the ice from contamination while it is stored within the ice bin assembly. A drain pan is located below the dispensing valves to catch any spillage and direct it to the drain piping. The drain pan can have a primary drain pipe and a secondary drain pipe. The ice bin assembly can have an outer wall structure and an inner wall structure. The outer wall structure can be seamless.

### CROSS-REFERENCE TO RELATED APPLICATIONS

This patent application claims the benefit of U.S. Provisional Patent Application No. 60/990,593, filed Nov. 27, 2007, which is incorporated by reference in its entirety herein.

### BACKGROUND

Drop-in beverage dispensing units have been plagued by numerous problems over the years. U.S. Pat. No. 6,761,036 (Teague, et al.) describes a beverage dispenser with an integral ice maker, which is a common product in the industry. Drop-in dispensers are prone to problems such as fluid seepage into insulation around the riser lines and the carbonator tank. They are also prone to fluid accumulation and overflow, which causes mold build-up around the unit. Insulation exposure around the top of the bin also causes mold and bacteria build-up.

Another problem with drop-in dispensers is that the outer bin wall encounters structural weakness. Fluid leaks often occur in the inner bin area at the interface between the inner liner and the cold plate. Additionally, leaks in the inner bin area occur due to poor support of the cold plate and the weight of the cold plate and ice. This causes the inner bin and seams to droop, which can result in further leakage. Furthermore, the drain lines are not vented and fluid cannot exit the unit, which results in fluid drain problems.

The cold plate lines coming out from the cold plate are prone to damage due to stress applied to the lines when the unit is set down on a surface without the support of the stand. More general support problems also occur because current units utilize stand structures incapable of supporting the loads of the dispensing unit or supporting the unit when it is moved. Finally, the drop-in dispensers are difficult to de-construct for cleaning purposes, and difficult and expensive to deconstruct and rebuild for refurbishing purposes.

### BRIEF SUMMARY

The beverage dispensing unit and ice bin combination comprises features for providing a water-proof construction of a beverage-dispensing unit. For example, the beverage dispensing unit may comprise features that do not allow fluid to seep into insulation around the cold plate outlet lines and the carbonator tank. The beverage dispensing unit may also comprise features that block fluid overflow and accumulation that may cause mold build-up around the unit. Additionally, the invention may provide an improved fluid drainage system by providing a double-drain construction to prevent overflow, and air flow vents to prevent air lock and blockage. The beverage dispensing unit may also have a drain system with a single drain pan that provides redundant drain capability in case of a plugged drain or an overflow. This drain pan may allow fluid to flow to the drains as well as overflow to the rear of the pan.

The beverage dispensing unit may also comprise a construction such that the insulation is not prone to exposure that causes mold and bacteria. This construction may include a stainless steel structure along the top surface of the unit to prevent the exposure and a more stable tower. The invention's construction may also include a single-structure outer ice bin wall with a more robust outer wall. Additionally, the unit may provide an improved fastening method and construction for the dispensing valves, as well as provide a construction that eliminates fluid leaks between the inner wall and the cold plate due to separation of the surfaces.

The unit may also comprise a stand of improved construction to better allow placement, movement, and cleaning of the unit. This stand may include less exposed fasteners, easily replaceable legs, and the general construction may be easier to de-construct for cleaning purposes as well as easier and less expensive to refurbish. The beverage dispensing unit may comprise features that protect the cold plate lines when moving or setting up the unit, and may comprise a manifold block to allow easy configuration of fluid and syrup supply lines. Finally, the beverage dispensing unit and ice bin combination may have a drain pan to host a number of ice trays in different configurations.

### BRIEF DESCRIPTION OF THE DRAWINGS

FIG. 1 is an exploded perspective view of the beverage dispensing unit and ice bin combination.

FIG. 2 is a top perspective partial view of the beverage dispensing unit and ice bin combination showing internal components of the tower assembly of the beverage dispensing unit and ice bin combination of FIG. 1.

FIG. 3 is a right-side section view of the ice bin assembly shown in FIG. 1.

FIG. 4 is a partial section view showing the tower assembly of the beverage dispensing unit and ice bin combination of FIG. 1.

FIG. 5 is a top plan view of the stand shown in FIG. 1.

FIG. 6 is a front elevational view of the stand shown in FIG. 1.

FIG. 7 is a right elevational side view of the stand shown in FIG. 1.

### DETAILED DESCRIPTION

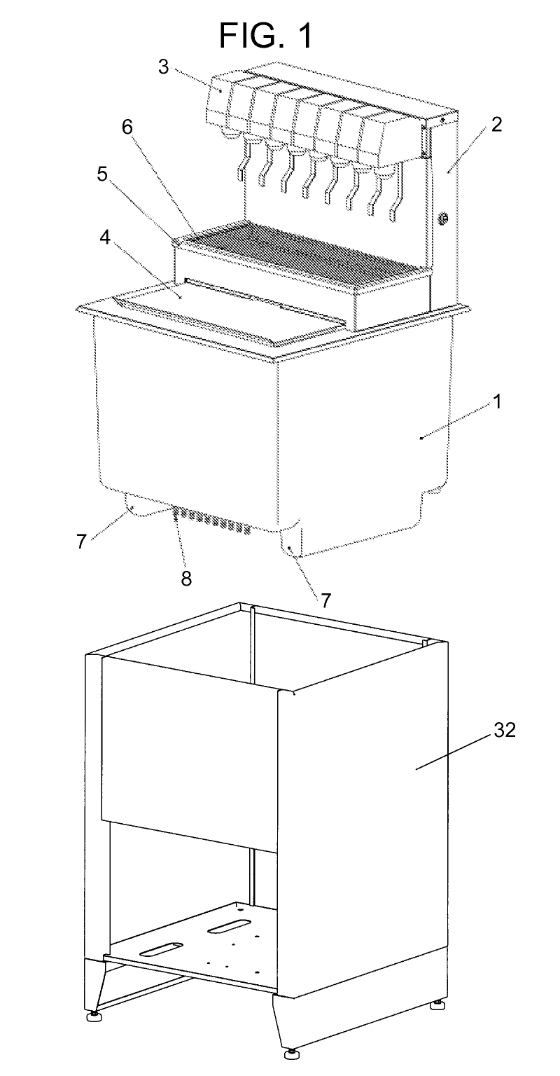

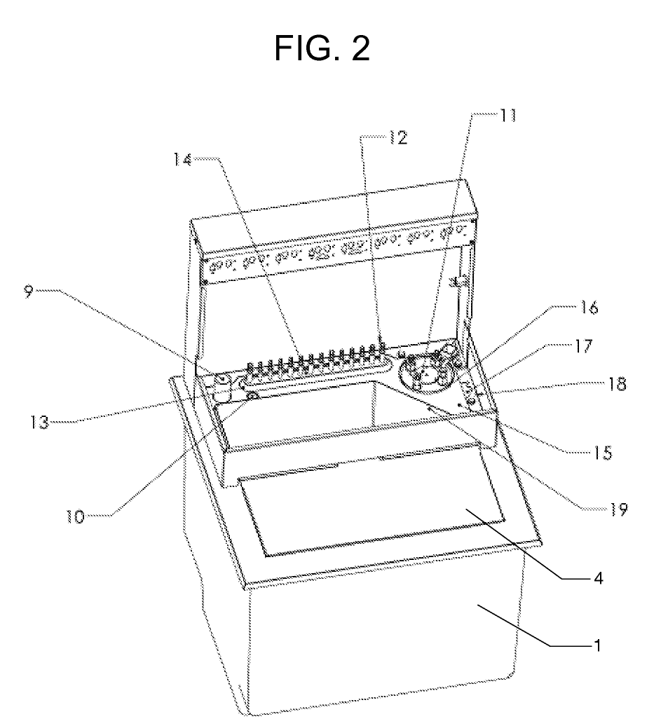

Referring to FIGS. 1-3, the beverage dispensing unit and ice bin combination is a drop-in beverage dispensing unit which may comprise an ice bin assembly 1 and a beverage dispenser that can have a tower assembly 2 onto which dispensing valves 3 are mounted. An ice bin lid 4 can provide access to the ice stored within the ice bin assembly and can aid in protecting the ice from contamination while it is stored within the ice bin assembly. A drain pan 5 may be located below the dispensing valves to catch any spillage or excess fluid. The drain pan 5 can be inclined to direct any excess fluid to drain piping, such as primary drain pipe 9. A grid 6 can be disposed above the drain pan 5, to support a cup or similar vessel thereon while permitting excess fluid to enter the drain pan 5.

The drain system can include a primary drain pipe 9 and a secondary drain pipe 10. The secondary drain pipe can act as a vent to prevent air lock, thus allowing greater draining capacity. In some embodiments, the secondary drain pipe provides a controlled drain for overflow occurring within the tower assembly.

The beverage dispensing unit and ice bin combination provides further protection from overflow by containing the overflow within the tower assembly. Instead of allowing the overflow to penetrate under the tower, and ultimately out behind the tower, the beverage dispensing unit and ice bin combination contains overflow fluid within the tower until it has fully drained into the secondary drain pipe. A gasket 17 can be disposed below the tower flanges 18 to prevent fluid from penetrating below the tower assembly. The top edge of the inner ice bin wall 19 can also aid in containing overflow by preventing fluid from spilling into the ice bin.

The beverage dispensing unit and ice bin combination provides protection to the areas of the beverage dispensing unit and ice bin combination that are commonly susceptible to mold and bacteria build up. An ice bin surface 15 can fully cover and protect the foam insulation below. The ice bin surface 15 can be constructed of any suitable material, including, but not limited to stainless steel. A raised lip 16 on the stainless steel ice bin surface can be used to surround the carbonator 11 to protecting it from fluid. The invention also protects the insulation around the cold plate outlet lines 12 from fluid. The cold plate outlet lines can be located on a raised ice bin surface 13, and a gasket 14 can seal the surrounding insulation.

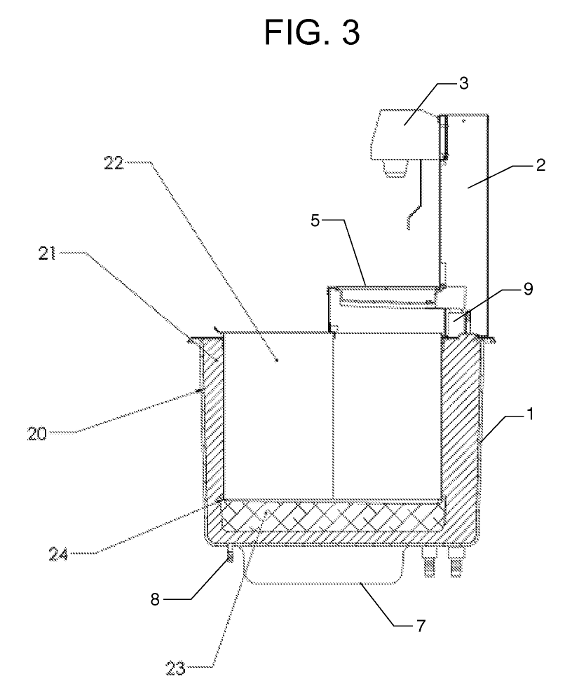

Referring to FIG. 3, the ice bin assembly can include a single-structure outer ice bin wall 20 which provides a robust ice bin assembly. The single structure outer ice bin wall also can provide greater resistance to fluid leaks from within the ice bin. In certain embodiments, the beverage dispensing unit and ice bin combination can have no joints or seams in the outer ice bin wall, and thus, the outer ice bin wall is not susceptible to separation. The inner ice bin wall 22 may be joined to the cold plate 23 and both may be encapsulated in a foam material such as a closed-cell structural foam 21. This construction can provide a sealed interface between the inner ice bin wall and cold plate 24. Furthermore, the inclusion of a single-structure outer ice bin wall can ensure that if damage were to occur to the interface, fluid from within the ice bin would not penetrate the outer ice bin wall.

The beverage dispensing unit and ice bin combination can have ice bin legs 7 on the base of the ice bin assembly that raise the unit to the necessary height to protect the cold plate inlet lines 8 from damage during placement or movement of the unit.

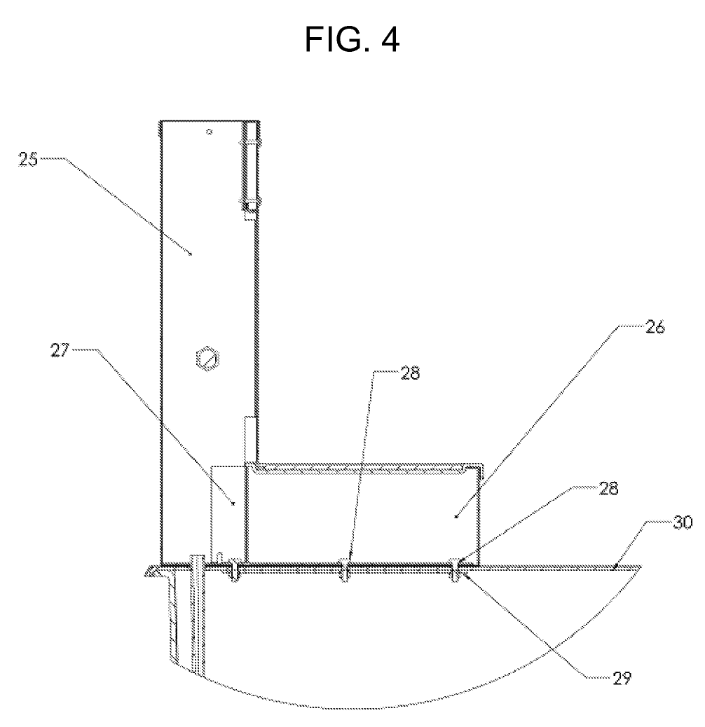

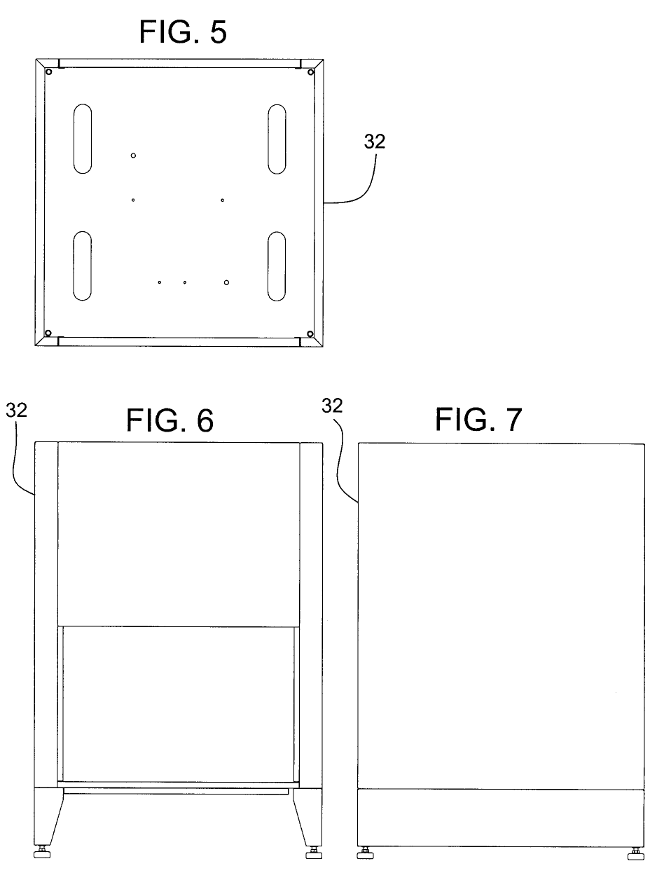

The beverage dispensing unit and ice bin combination's tower assembly 2 is stable and durable. Turning to FIG. 4, the tower 25 can be joined to the drain pan base 26 resulting in a single structure. One or more flanges 27 located on the left and right sides of the drain pan base can be joined to the tower by means of, but not limited to, welding or structural adhesive. As an alternative embodiment, the flanges may be located on the tower. The tower assembly can be secured to the ice bin with several bolts 28 that mate with one or more thread plates 29 on the underside of the ice bin top 30. This method of fastening the tower assembly to the ice bin is strong and resistant to the tower being separated from the ice bin. The tower and ice bin combination can be removably inserted into a stand 32 as illustrated in FIGS. 1 and 5-7.

What is claimed is:

1. A beverage dispensing unit and ice bin combination, the combination comprising:
a beverage dispenser having a valve for dispensing a beverage, a drain pan for receiving excess fluid, a primary drain pipe, and a secondary drain pipe, the drain pan being disposed below the valve and connected to the primary drain pipe for exiting excess fluid from the drain pan, the secondary drain pipe being disposed below the drain pan to exit fluid accumulating below the drain pan; and
an ice bin assembly disposed below the beverage dispenser, the ice bin assembly having an inner wall structure for containing ice.

2. The beverage dispensing unit and ice bin combination of claim 1 wherein the secondary drain pipe operates as a vent to improve drainage through the primary drain pipe.

3. The beverage dispensing unit and ice bin combination of claim 1 wherein the beverage dispenser further comprises a tower assembly for supporting the valve and the drain pan over the ice bin assembly.

4. The beverage dispensing unit and ice bin combination of claim 3 further comprising a gasket disposed between the tower assembly and the ice bin assembly to resist fluid from exiting between the tower assembly and the ice bin assembly.

5. The beverage dispensing unit and ice bin combination of claim 3 wherein the tower assembly includes a tower supporting the valve and a drain pan base supporting the drain pan, at least one of the tower and the drain pan including a flange attached to the other of the tower and the drain pan.

6. The beverage dispensing unit and ice bin combination of claim 1 further comprising a carbonator surrounded by a raised lip.

7. The beverage dispensing unit and ice bin combination of claim 1 wherein the ice bin assembly further comprises a cold plate.

8. The beverage dispensing unit and ice bin combination of claim 7 wherein the ice bin assembly has a base, and wherein the ice bin assembly further comprises a cold plate inlet line connected to the cold plate, and the ice bin assembly further comprises a leg for supporting the ice bin assembly on a surface, the cold plate inlet line and the leg extending from the base such that the leg extends farther from the base than the cold plate inlet line to protect the cold plate inlet line when the ice bin assembly is placed on the surface.

9. The beverage dispensing unit and ice bin combination of claim 7 wherein the ice bin assembly further comprises a raised surface and a cold plate outlet line is disposed on the raised surface and connected to the cold plate.

10. The beverage dispensing unit and ice bin combination of claim 1 wherein the ice bin assembly further comprises an outer wall structure, the inner wall structure being disposed within the outer wall structure.

11. The beverage dispensing unit and ice bin combination of claim 10 further comprising a foam material disposed between the inner wall structure and the outer wall structure.

12. The beverage dispensing unit and ice bin combination of claim 10 wherein the outer wall structure is seamless.

13. The beverage dispensing unit and ice bin combination of claim 1 further comprising a stand for removably receiving and supporting the ice bin assembly.

14. A beverage dispensing unit and ice bin combination, the combination comprising:
a beverage dispenser having a valve for dispensing a beverage and a drain pan for receiving excess fluid, the drain pan being disposed below the valve; and
an ice bin assembly disposed below the beverage dispenser, the ice bin assembly having an inner wall structure for containing ice and a seamless outer wall structure, the inner wall structure being disposed within the outer wall structure.

15. The beverage dispensing unit and ice bin combination of claim 14 further comprising a foam material disposed between the inner wall structure and the outer wall structure.

16. The beverage dispensing unit and ice bin combination of claim 14 wherein the ice bin assembly further comprises a cold plate.

17. The beverage dispensing unit and ice bin combination of claim 16 wherein the ice bin assembly has a base, and wherein the ice bin assembly further comprises a cold plate inlet line connected to the cold plate, and the ice bin assembly further comprises a leg for supporting the ice bin assembly on a surface, the cold plate inlet line and the leg extending from the base such that the leg extends farther from the base than the cold plate inlet line to protect the cold plate inlet line when the ice bin assembly is placed on the surface.

18. The beverage dispensing unit and ice bin combination of claim 16 wherein the cold plate is joined to the inner wall structure.

19. The beverage dispensing unit and ice bin combination of claim 14 wherein the beverage dispenser further comprises a tower assembly for supporting the valve and the drain pan over the ice bin assembly.

20. The beverage dispensing unit and ice bin combination of claim 14 further comprising a stand for removably receiving and supporting the ice bin assembly.
